(19) United States
(12) Patent Application Publication
(10) Pub. No.: US 2010/0241441 A1
(43) Pub. Date: Sep. 23, 2010

(54) AUTOMATED SCAT SYSTEM

(75) Inventors: Janice Page, Lake Forest Park, WA (US); Kevin Gabel, Vancouver, WA (US); Joel Hancock, Seattle, WA (US)

Correspondence Address: JACKSON WALKER, L.L.P., 112 E. PECAN, SUITE 2400, SAN ANTONIO, TX, 78205, US

(73) Assignee: ENTRIX, INC.

(21) Appl. No.: 12/727,702

(22) Filed: Mar. 19, 2010

Related U.S. Application Data
(60) Provisional application No. 61/161,477, filed on Mar. 19, 2009.

(51) Int. Cl. G06Q 50/00; H04N 5/228; G01S 19/42; G06F 17/30

(52) U.S. Cl. 705/1.1; 348/222.1; 342/357.25; 707/803; 707/756; 707/E17.006

(57) ABSTRACT

An electronic shoreline cleanup and assessment system includes a plurality of hardware and software elements configured to provide automation and greater efficiency for SCAT teams. In an exemplary embodiment, teams use digital cameras and GPS receivers programmed with data dictionaries in their survey efforts. Collected data can be synchronized with a laptop computer, which can then wirelessly transmit data to an environmental command center. The environmental command center can operate a central computer and central database, which permit useful operations with the gathered data.

### CROSS REFERENCE TO RELATED APPLICATIONS

This application claims the benefit of U.S. provisional application 61/161,477, entitled “Automated SCAT System,” filed Mar. 19, 2009. The foregoing is incorporated herein by reference.

### BACKGROUND

This specification relates to the field of environmental protection, and more particularly to an automated system and method for shoreline cleanup assessment.

As part of an oil spill response, a Shoreline Cleanup Assessment Technique (SCAT) team uses a systematic survey and recording approach on affected shorelines. The SCAT work provides a rapid and accurate geographic picture of oiling conditions. SCAT was first developed by Exxon for the efficient cleanup and treatment of stranded oil from the 1989 Valdez oil spill in southeast Alaska. Since then, SCAT has evolved into a tool accepted by industry, the U.S. Coast Guard, the National Oceanic and Atmospheric Administration (NOAA), and foreign governments. Moreover, SCAT is used on spills throughout the United States and in South America

SCAT surveys are based on a set of terminology and definitions that must be flexible enough to adapt to any spill situation. The goals SCAT surveys include mapping the character of the oiled shoreline, documenting the nature of the oiling conditions, identifying environmental concerns, making cleanup recommendations, and assessing cleanup efforts. The SCAT process can involve three levels of survey effort:

1. Aerial Reconnaissance SCAT Survey: This allows quick assessment of the shoreline geomorphology and oiling conditions and this assists in prioritizing resources and segmenting the shoreline for SCAT mapping.

2. Aerial Videotape SCAT Survey: The acquisition of aerial videotape imagery provides a baseline of the oiling conditions and provides a rapid assessment tool for mapping the character of the shoreline oiling conditions for large sections of coast. Not only does this survey provide information on the geomorphology of the coast and the oiling conditions, but information is also provided on site access and other relevant information to support cleanup operations.

3. Systematic Ground SCAT Survey: The ground survey involves subdividing the coastline into shoreline segments that are subsequently walked. The shore zone and oiling character are then mapped using standardized terminology and forms.

### BRIEF DESCRIPTION OF THE DRAWINGS

FIG. 1 is a diagrammatic view of a SCAT team surveying a SCAT segment;

FIG. 2 is a diagrammatic view of a SCAT team synchronizing data after completion of a SCAT segment;

FIG. 3 is a diagrammatic view of an environmental command center; and

FIGS. 4 and 4A are a diagrammatic view of an exemplary data structure for a central database.

### SUMMARY OF THE INVENTION

In one aspect, an electronic shoreline cleanup and assessment system includes a plurality of hardware and software elements configured to provide automation and greater efficiency for SCAT teams. In an exemplary embodiment, teams use digital cameras and GPS receivers programmed with data dictionaries in their survey efforts. Collected data can be synchronized with a laptop computer, which can then wirelessly transmit data to an environmental command center. The environmental command center can operate a central computer and central database, which permit useful operations with the gathered data.

### DETAILED DESCRIPTION OF THE EMBODIMENTS

The present specification discloses a SCAT system and method whereby a combination of hardware and software elements are combined to significantly increase the efficiency of SCAT teams. Hardware elements of the present specification may include the following:
Handheld GPS receivers, such as the Trimble Juno ST;
Digital cameras;
Field computers, such as laptop computers;
A central computer, such as a server, including a networked data storage system.

Software components of the present specification may include the following:
A database management system (DBMS) configured to allow a programmer to interface with multiple databases, such as dBase.
Geographic Information System (GIS) software configured to permit data tables to be entered into a map format, such as ArcGIS.
Field software provided with appropriate data dictionaries and configured for fast and efficient data collection and maintenance on a GPS receiver, such as Trimble Pathfinder Office; and
A central database configured to be run on the central computer, such as Microsoft Access.

An automated SCAT system will now be described with more particular reference to the attached drawings. Hereafter, details are set forth by way of example to facilitate discussion of the disclosed subject matter. It should be apparent to a person of ordinary skill in the field, however, that the disclosed embodiments are exemplary and not exhaustive of all possible embodiments.

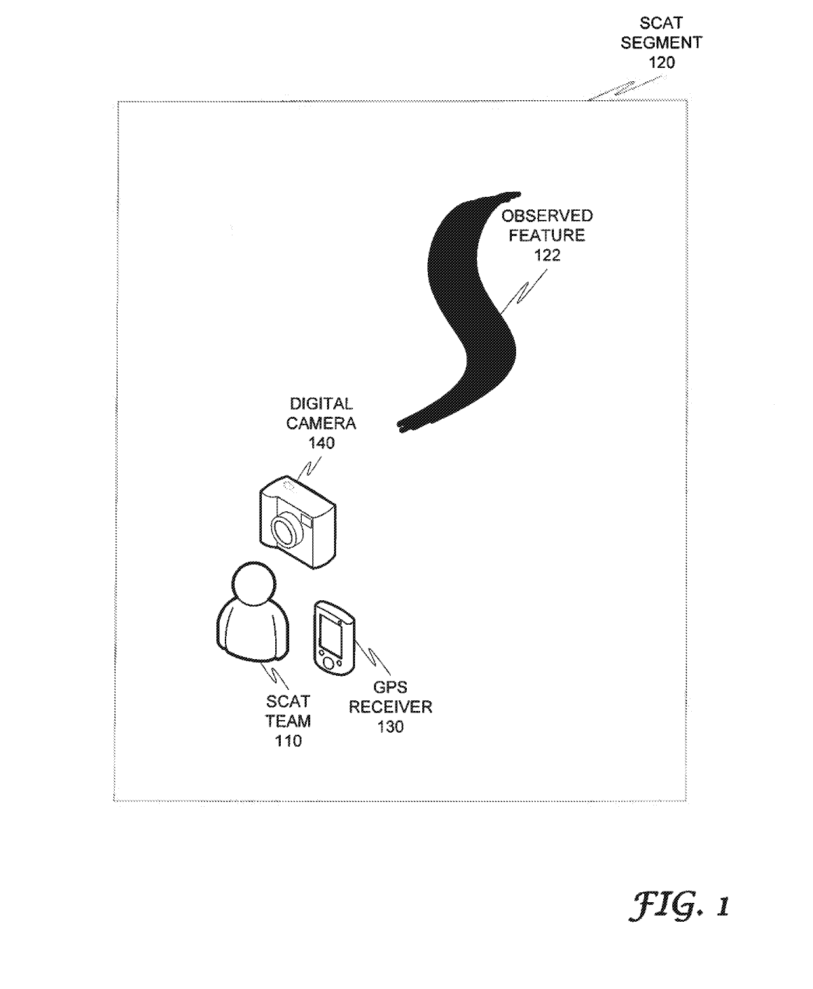

FIG. 1 is a diagrammatic view of a SCAT team 110 surveying a SCAT segment 120. SCAT team 110 may consist of one or more people, including such members as an experienced oil observer, a responsible party representative, a federal representative, a state representative, a land owner or land manager, and/or a local community representative. SCAT segment 120 may include an observed feature 122, such as an oiled band, tar ball, wildlife, debris patch, or other item of interest. SCAT team 110 operates a GPS receiver 130, such as, for example, a Trimble Juno ST GPS receiver running Trimple Pathfinder software. GPS receiver 130 may include such elements as a GPS antenna for receiving GPS data and an input/output device for interfacing with a user. SCAT team 110 also operate a digital camera 140 or other photographic device. The use of GPS receiver 130 permits SCAT team 110 to automatically receive coordinates of observed feature 122 while details about it are being recorded. Photographs taken with digital camera 140 may also be associated with a particular geographic coordinate.

In one exemplary method, SCAT team 110 will set out in the morning and will systematically walk and observe SCAT segment 120, using data dictionaries available on GPS receiver 130 to catalog important observations. To use the system of the instant invention, aerial imagery of a spill site is uploaded into each GPS receiver 130. This may be done, for example, by using Trimble Pathfinder Office software. The imagery should encompass the entire region of the spill. Then, a data dictionary specific spill scenario may be constructed using software, for example Trimble Pathfinder Office. Such a dictionary should include all shoreline, debris, and wildlife types that may be encountered and all team member names that are on the scene. After each first time user is trained on the data collection method and is calibrating the oil levels consistently, a vector shoreline layer is created in GIS format that can later be used to display oiling status along the shoreline. Then, a division map is created that splits up the potentially affected shoreline(s) into equally spaced SCAT segments 120. Each SCAT team 110 is then provided with one GPS receiver 130, one digital camera 140, and one field laptop computer equipped with a wireless communication device such as a USB modem. SCAT team 110 is then assigned one or more SCAT segments 120 on a daily basis. Once SCAT team assignments are determined, SCAT team 110 travels to SCAT segment 120 and commences the SCAT survey. Using GPS receivers 130, SCAT team 110 creates a data dictionary for each day's assigned survey. This file contains all collected field data.

SCAT teams 110 should work as a group to assess the shoreline oiling distribution. The team members must reach an agreement on oiling levels and enter information accordingly into the data dictionary of the GPS receiver 130. All required fields must be completed, as well as any additional fields that are necessary based on field observations (wildlife/debris encounters, sediment sample, trench dig, etc.).

In the exemplary embodiment, GPS receiver 130 is provided with software that enables it to have a data dictionary that categorizes the features, attributes, and acceptable attribute values that match the data structure of the GIS database or central database. Using a data dictionary improves efficiency and ease of use in the field, with timesavers like pre-defined dropdown menus and automatic generation of date and time values. GPS receiver 130 may also be programmed with aerial imagery that encompasses the entire spill area. Both the aerial imagery data and the dictionary fields enable SCAT team 110 to enter survey data from its GPS receiver 130 in a predefined field area. GPS receiver 130 can be programmed with a data dictionary containing 3 data gathering options or “points”. Below is a description of the intended use of each point and instructions on collecting the data.

### Start SCAT

This data collection option is intended to designate the start location of the SCAT segment.
Segment ID—This should be entered exactly as it appears on the information obtained from the Environmental Unit in the command center. This should be entered in ALL CAPS
Date—This field will be populated automatically by the field unit
Time—This field will be populated automatically by the field unit

### Stop SCAT

This data collection option is largely self explanatory and follows, very closely, the NOAA Short SCAT Form.
Segment ID—This should be entered exactly as it appears on the information obtained from the Environmental Unit in the command center. This should be entered in ALL CAPS.
Date—This field will be populated automatically by the field unit.
Time—This field will be populated automatically by the field unit.
Tide Height—The current stage of the tide (if applicable).
Survey Method—How is the survey being conducted?
Weather—The current weather
SCAT Team ID—The team # that was assigned to you during the SCAT team briefing.
Primary Shoreline—The primary type of shoreline encountered along the segment
Secondary Shoreline1—The secondary type of shoreline encountered along the segment
Secondary Shoreline2—Any other type of shoreline encountered along the segment
Shoreline if Other—If the type is shoreline is not in the drop-down list, describe it here.
Oiled Debris—Is there any oiled debris along the segment?
Oiled Debris Type—What kind of oiled debris was encountered?
Backshore Access—Is there physical access to the segment from the back side of the shoreline?
Alongshore Access—Is there access to the segment along the shoreline?
Access Restrictions—What are the physical limitations that prevent access to the segment?
Backshore Staging—Could a staging area be set up at some point along the segment?
Oil Zone 1—The location of the primary oiled zone
Zone 1 Width (m)—The width of the oiled band, in meters
Zone 1 Length (m)—The length of the oiled band, in meters
Zone 1 Distribution—Within the oiled zone, what percent of ground is covered by oil?
Zone 1 Thickness—The average thickness characteristic of the oil
Zone 1 Type—The physical character of the oil
Zone 1 Penetration—How deep in to the sand, mud etc. has the oil penetrated?
Oil Zone 2—The location of the secondary oiled zone (if applicable)
Zone 2 Width (m)—The width of the oiled band, in meters
Zone 2 Length (m)—The length of the oiled band, in meters
Zone 2 Distribution—Within the oiled zone, what percent of ground is covered by oil?
Zone 2 Thickness—The average thickness characteristic of the oil
Zone 2 Type—The physical character of the oil
Zone 2 Penetration—How deep in to the sand, mud etc. has the oil penetrated?
Cleanup Recommended—Should a cleanup crew be dispatched to the segment?
Photo # or Range—If pictures were taken, list the photo #(s) here
Comments—Any additional info?
See Notes—Were additional notes or descriptions/drawings entered into a field notebook?

### Other Observations

This data collection point is intended to capture all sampling locations along the SCAT segment.
Segment ID—This should be entered exactly as it appears on the information obtained from the Environmental Unit in the command center. This should be entered in ALL CAPS.
Date—This field will be populated automatically by the field unit.
Time—This field will be populated automatically by the field unit.

Sample:
Sample ID—Populate with Sample ID—See protocols
Sample Media—This field should be populated with the media of sample collected.
Sample Type—This field should be populated with the type of sample collected. The options include:
   1. Background—This type of sample refers to a sample collected in the general oiling area but not within the actual oil, such as clean segments within the general oiling location.
   2. Reference—This type of sample refers to a sample collected outside of the general oiling area where no oil has been potentially deposited. The Segment ID should reflect that this was taken on a reference segment.
   3. In Oiling Band—This type of sample refers to a sample collected directly under the oiling band within the segment.
Sample Depth—This field should be populated with the depth of the sample taken.
Depth Units—This field should be populated with the unit of measure of the above Sample Depth field.

Wildlife—This data field is intended to capture (if requested) live wildlife along a SCAT segment.
Species—This field should be populated with the type of wildlife observed to the best level possible (i.e. Bird, Species)
Status—the physical status of the animal
Count (total)—Total # of this species observed
Amount (oiled)—Of the total, how many are oiled?

Debris Patch—This data field is intended to capture any large pieces of debris along a SCAT segment.
Primary Type—Populate this field with the primary debris type.
Secondary Type—Populate this field with any secondary debris type(s)
Location—Indicate the location of the debris along the shoreline or in the water.
Environmental Threat—Indicate to the best of your ability, the environmental threat.
Navigational Threat—Indicate to the best of your ability, the threat to navigation.
Approx Area/Size—Indicate the approximate size or area of the debris.

Trench—This data field is intended to capture any trenches dug for sub-surface oil detection.
Trench ID—See protocols
Trench Depth—Populate with trench depth in centimeters.
Depth to Oil—Populate with the depth to oil in centimeters.
Oil Thickness—Populate this field with the thickness of the submerged oil
Depth to Water—Populate with the depth to the water table in centimeters.
Sheen—Populate this field with the type of sheen observed, if any

General Info
Photo # or Range—This field should be populated with the photo or photos taken of the trench.
Your name—The name of the SCAT team leader
Comments—Record any comments about the observations in this field.

SCAT team 110 may work under the following process. As one skilled in the art will appreciate, the following instructions are exemplary, and other instructions employing different data dictionaries can be used and are encompassed within the scope of this disclosure.

SCAT Data Collection Operational Guidelines:
Obtain a GPS receiver 130 labeled according to the SCAT team (i.e. Team 1 or T1). A GPS receiver with an accessible download cable is preferable.
Check the coordinate system on GPS receiver 130 to ensure that it is set to decimal degrees prior to conducting SCAT survey. If it is not set on this coordinate system, do so at this time.
Create a new data file labeled according to the SCAT team number and date (i.e. T1-031910).
Open and activate the “SCAT” data dictionary.
Follow the ESCAT instructions.
At the end of a day of surveying bring GPS receiver 130 to GIS operator 330 (FIG. 3) for downloading. Also, be sure to bring additional handwritten notes and digital camera 140.

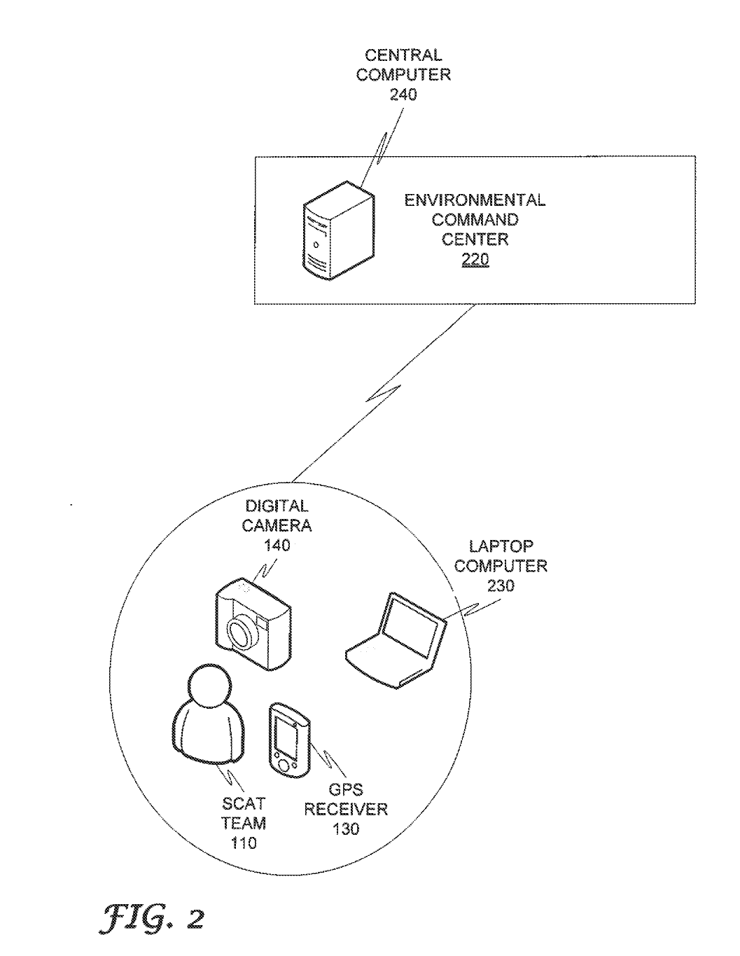

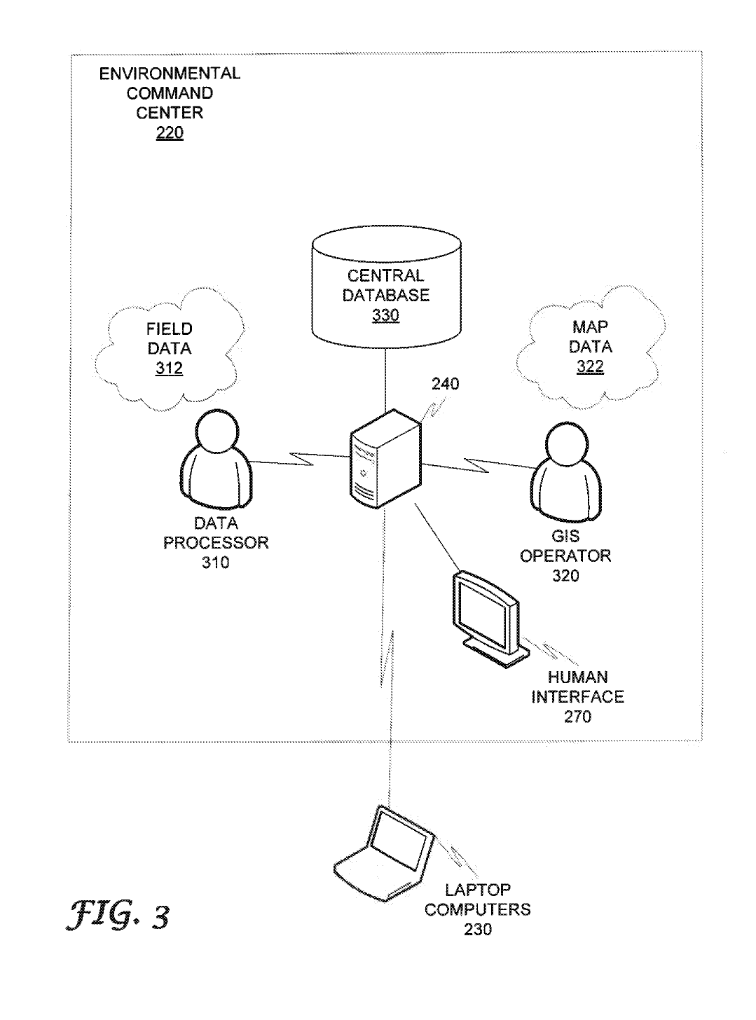

As shown in FIG. 2, at the end of the day, or when they are finished with the segment, SCAT Team 110 can upload data from GPS receiver 130 and digital camera 140 locally to a laptop computer 230. Laptop computer 230 may include such software as a data management program, for example Trimble Pathfinder Office, and photographic metadata software, for example GPS Photolink. In some embodiments, laptop computer 230 may also include GIS software such as ArcGIS. Laptop computer 230 can then synchronize its data with a central computer 240 located at environmental command center 220.

In one exemplary embodiment, to transmit data back to the central computer 240, a Trimble Juno ST is connected to laptop 230 via a USB cable. Using the Trimble Pathfinder Office™ file manager, the field data file is selected and sent via email.

FIG. 3 provides a more detailed diagrammatic view of operations at environmental command center 220. As seen in this figure, a plurality of laptop computers 230 may provide field data from a plurality of SCAT teams 110. Environmental command center 220 includes a central computer 240, which may be a server, workstation, or other suitable computing device. Central computer 240 may include a DBMS or other software suitable for communicating with a plurality of data elements in different formats. A central database 330 is provided, which contains all information gathered by the SCAT and cleanup effort. Central database 330 may be hosted on a networked storage device. A data processor 310 interfaces with central computer 240 and is tasked with preparing and formatting field data 312 for use with central database 330. There is also a GIS operator 320 who receives map data 322, which may include, for example, GPS coordinates and shapefiles. GIS operator 320 is tasked with extracting map data 322 from GPS receivers 130 and preparing and formatting map data 322 for use with central database 330. A human interface 270, which may include such input and output elements as a display monitor, keyboard, mouse, microphone, and speakers, is provided to permit human interaction with central computer 240 and central database 330.

There are several methods that can be used to interconnect the data generated by a GPS receiver 130 running software such as Trimble Pathfinder Office to a central database 330, and a mapping application, such as ArcGIS. For example, after all GPS receivers 130 are given to the GIS operator 320, GIS operator 320 downloads and exports all field data to a format for use in central database 330, as well as shapefile format. Using the Start_SCAT and Stop_SCAT points (shapefiles) in GIS software, the pre-existing vector shoreline layer is split and color-coded to illustrate shoreline oiling status. This data is displayed on oiling status maps and shown at daily briefings. Wildlife encountered, sediment sample locations, and trench locations can also be plotted on maps for display.

Once SCAT team 110 has completed survey of SCAT segment 120, SCAT team 110 can download the field data 312 to laptop computer 230. Field data 312 can then be sent to central computer 240. Handwritten notes and samples may also be transported to environmental command center 220 so that they may be linked in the database to the appropriate segment location. If SCAT team 110 must go back into the field to verify and update GIS data, GPS receiver 130 can upload waypoint files to help navigate the points in the SCAT segment which SCAT team 110 wishes to revisit. For example, a color-coded map with an aerial photo or satellite image in the background for reference can be generated to enable navigation back to a marked observation point. Once a user has re-visited the observation point, the Trimble Pathfinder Office™ software automatically marks it as updated so that central command can keep track of revisited observation points.

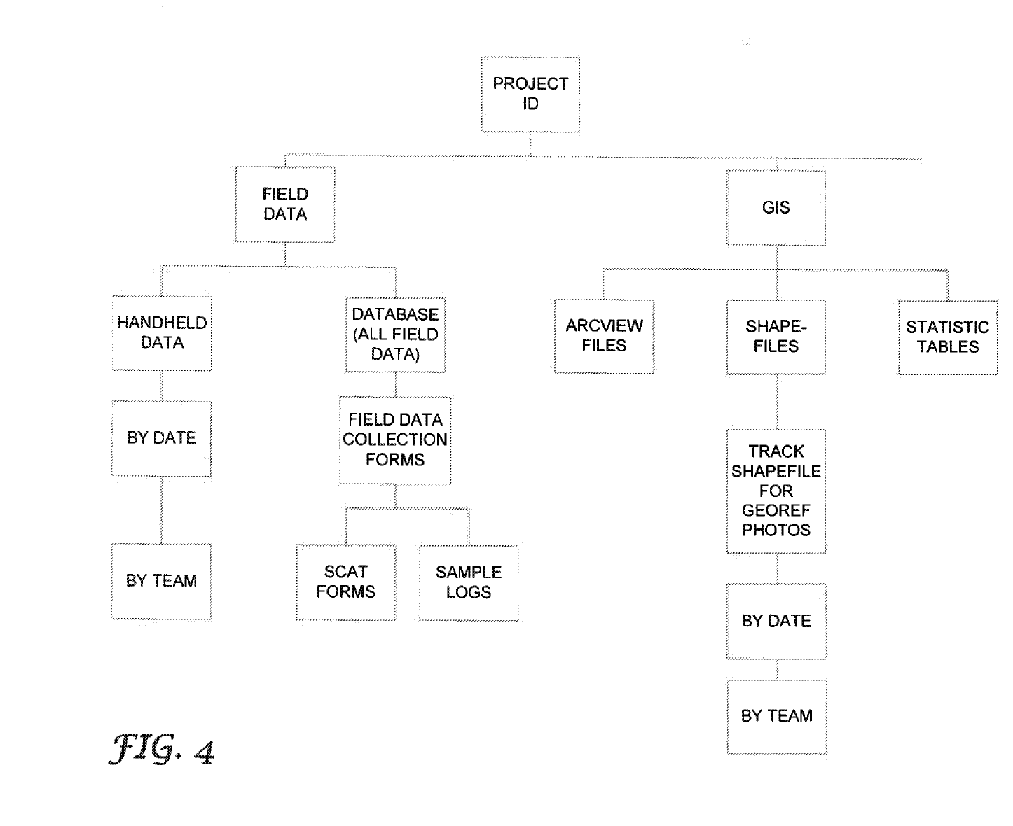

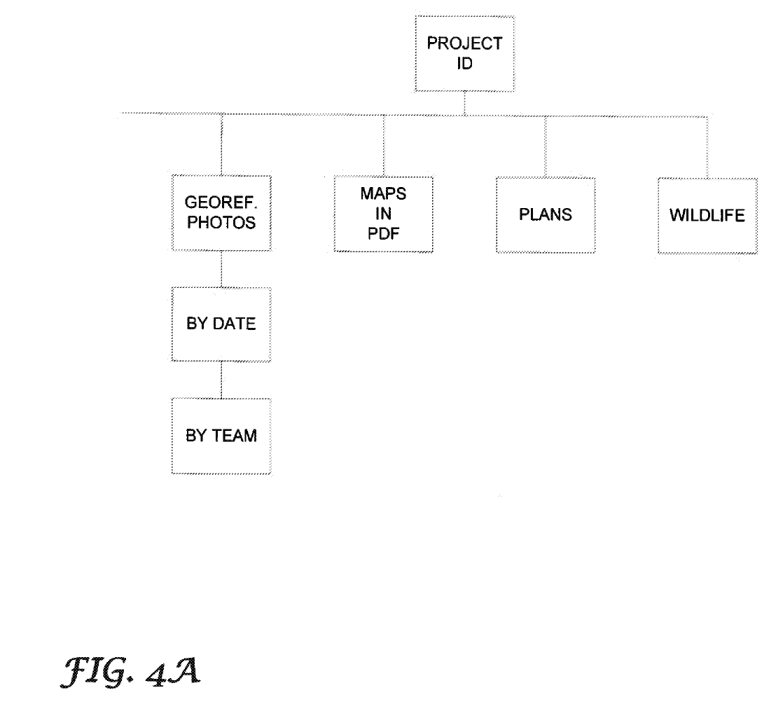

FIGS. 4 and 4A disclose an exemplary structure for a central database 330. Central computer 240 stores the collected field data, shapefiles, and photos and links these to central database 330. Each of these files can be accessed by central computer 240 and presented to the user in multiple formats. For example, ArcGIS can be used to provide interactive data on a map of each SCAT segment, or the entire spill area. This allows personnel at environmental command center 220 to review observation data, update changes, inform interested parties of efforts and execute clean-up efforts in an organized and logical way. And because data are entered in a GPS receiver 130 at an observation site in a SCAT segment, there is less room for data entry error.

The attribute information that is exported to central database 330 is used to populate a digital SCAT form as follows:
Tables are imported into central database 330 and Start_SCAT, Stop_SCAT, and/or Other Observations append tables are overwritten by replicating naming conventions;
An append query is performed on designated tables to add new records to Start_SCAT, Stop_SCAT, and/or Other Observations Master table;
New records appended in tables are automatically added to central database forms that populates a digital template resembling a SCAT form for each SCAT segment;
Forms are printed directly from central database 330 and remain stored therein;
Photos from each digital camera are downloaded into folders named according to SCAT team and date;
Software such as GPS Photolink is used to link digital photos to the GPS receiver tracklog for an overview of each photo.

In the exemplary structure of FIGS. 4 and 4A, all data are entered under a project identifier, such as a project name identifying the cleanup effort. All data are saved by project name and number, with separate database structures for the field data, GIS data, geo-reference photographs, PDF maps, plans for the clean-up operation, and wildlife data. These data are structured as follows:
Field Data—Field data may include data collected from GPS receivers 130, which may be keyed for sorting by date or by team. It may also include a database of all field data as collected on field data collection forms, including handwritten SCAT forms and sample logs.
GIS—GIS data may include files in a format for use with a GIS program such as

ArcGIS, shapefiles, and statistical tables. Shapefiles may be correlated to georeference photos, and may be keyed for sorting by date and by team.
Georeference Photographs—Georeference photos may be keyed for sorting by date and by team.
Maps in PDF format.
Plans—Plans for clean-up operations.
Wildlife Data.

SCAT operations may be terminated when cleanup has reached an endpoint. Reaching an endpoint means that cleanup has been accomplished adequately (i.e., further cleanup effort doesn't make sense, because the remaining oil poses less risk than the cleanup activities, or cleanup is dangerous to personnel).

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

1. An GPS receiver comprising:
a user interface configured to perform input/output operations with a user;
a GPS subsystem configured to receive GPS data;
a plurality of data dictionaries comprising at least a Start_SCAT dictionary, a Stop_SCAT dictionary, and an Other Observations dictionary;
data collection software configured to present at least one input field to the user for each of the data dictionaries and to receive input from the user representing responsive to the input field presented and representing an observed condition of a shoreline cleanup assessment survey.

2. The GPS receiver of claim 1 wherein the GPS receiver is further configured to build a field database of observed data.

3. The GPS receiver of claim 2 wherein the GPS receiver is further configured to communicatively couple to a portable computer and to transfer the field database to the portable computer.

4. The GPS receiver of claim 1 wherein the GPS receiver has stored therein GIS data representing a SCAT survey zone.

5. The GPS receiver of claim 1 wherein the GPS receiver has stored therein aerial photographs of a SCAT segment.

6. A shoreline cleanup assessment system comprising:
a GPS receiver having stored thereon a data collection program and a plurality of data dictionaries, the data dictionaries comprising at least a Start_SCAT dictionary, a Stop_SCAT dictionary and an Other Observations dictionary, the data collection program configured to receive inputs from a user responsive to data fields of the data dictionaries and to build field data from the responses;
a portable computer configured to receive the field data from the GPS receiver and to wirelessly transmit the field data;
a central computer configured to wirelessly communicate with the portable computer and to receive the field data therefrom, the central computer communicatively coupled to a central database and having stored thereon a database management program operable to convert the field data into a format usable by the central database.

7. The system of claim 6 further comprising a GIS program configured to receive GIS data, and wherein the database management program is further configured to convert the GIS data into a format usable by the central database.

8. The system of claim 6 further comprising:
a digital camera; and
a digital photograph metadata program operable to associate GPS data with photographs taken by the digital camera.

9. The system of claim 6 wherein the GPS receiver has stored thereon GIS data representing a SCAT segment.

10. The system of claim 6 wherein the GPS receiver has stored thereon aerial photographs of a SCAT segment.

11. A method of performing shoreline cleanup assessment on an electronic shoreline cleanup assessment system, the electronic shoreline cleanup assessment system comprising a GPS receiver programmed with a plurality of data dictionaries, the data dictionaries comprising a Start_SCAT dictionary, a Stop_SCAT dictionary, and an Other Observations dictionary; a portable computer configured to communicatively interface with the GPS receiver; a central computer having stored thereon a database management system and communicatively coupled to a central database, the central computer further configured to wirelessly interface with the portable computer; the method comprising the steps of:
surveying a SCAT segment and operating the GPS receiver to record observations of the survey, recording observations comprising accessing at least one field from each of the data dictionaries and responsive to the field, entering an observed condition;
transferring the recorded observations from the GPS receiver to the portable computer;
wirelessly transmitting the recorded observations from the portable computer to the central computer;
operating the database management system to format the recorded observations for use in the central database; and
storing the formatted recorded observations in the central database.

12. The method of claim 11 further comprising taking digital photographs of observed features in the SCAT segment and using a digital photography metadata program to associate GIS data with the digital photographs.

13. The method of claim 11 further comprising pre-loading the GPS receiver with GIS data representing the SCAT segment.

14. The method of claim 11 further comprising performing a preliminary aerial reconnaissance survey of the SCAT segment.

15. The method of claim 14 further comprising performing a preliminary aerial video survey of the SCAT segment.

16. The method of claim 15 further comprising pre-loading the GPS receiver with aerial photographs of the SCAT segment taken from the preliminary aerial video survey.

17. The method of claim 11 further comprising synthesizing field data from a plurality of GPS receivers in the central database, the GPS receivers having data representing reported observations of a plurality of SCAT segments.

18. The method of claim 17 further comprising creating a visual representation of the plurality of SCAT segments and overlaying thereon graphical representations of observed features.

19. The method of claim 17 wherein the observed features include a features selected from the group consisting of an oiled band, a tar ball, wildlife, and a debris patch.
